(19) United States
(12) Patent Application Publication
(10) Pub. No.: US 2013/0173400 A1
(43) Pub. Date: Jul. 4, 2013

(54) AUDIENCE-DRIVEN REAL-TIME ADVERTISING SYSTEM

(71) Applicants: James Richard Koornneef, Whitby (CA); Aleksandar Sreten Zivkovic, North York (CA)

(72) Inventors: James Richard Koornneef, Whitby (CA); Aleksandar Sreten Zivkovic, North York (CA)

(21) Appl. No.: 13/726,464

(22) Filed: Dec. 24, 2012

Related U.S. Application Data
(60) Provisional application No. 61/581,078, filed on Dec. 28, 2011.

(51) Int. Cl. G06Q 30/02

(52) U.S. Cl. CPC G06Q 30/0277
USPC 705/14.73

(57) ABSTRACT

A server system for providing advertising to a user device, comprising: a memory; a processor operable to: receive messages from advertisers comprising advertising content for displaying on the device; send an advertising content removal offer to the device; determine an advertisement removal bid from the device; send advertising content to the device where the determined advertisement removal bid is a failing bid to remove the advertising content; refrain from sending the advertising content to the device where the server system is a successful bid; and store the advertisement removal bid. A computer implemented method of handling advertising, comprising: receiving messages from advertisers; sending an advertising removal offer to a device; determining an advertisement removal bid; sending advertising content on receiving a failing bid and refraining from sending advertising content on receiving a successful bid. A computer readable media containing computer executable instructions for the server system

### CROSS-REFERENCE TO RELATED APPLICATION

This application claims the benefit of U.S. Provisional Application Ser. No. 61/581,078, filed Dec. 28, 2011, which is herein incorporated by reference in its entirety.

### FIELD OF THE INVENTION

The invention relates to the field of electronic advertising for use with digital content. More particularly the present invention relates to servers for providing advertising to user devices. The present invention relates to computer-implemented methods for providing advertising to user devices and computer readable media for same.

### BACKGROUND

Media sales—especially videos (VHS, DVD, Blu-ray), books, and software, are often viewed differently depending whether someone is a creator/producer/generator/owner of the content or the viewer/listener/user/consumer of the same content. Content owners may see electronic sales proceeding as a licence to use, or a rental whereas the consumers have typically seen traditional book and software sales as purchase and ownership where they believe that for the particular hardcopy they have purchased and are in their possession, they should be able to resell or possibly loan that particular copy to a friend.

The difficulty in the age of digital and electronic media is that it is difficult to ensure that there is only one copy of the item. Sometimes the lender of an electronic file may still maintain a copy of the file being loaned out leading to unauthorized distribution of the content. Content owners have turned to Digital Rights Management (DRM) to prevent such unauthorized distribution but such strategies are not perfect. For example, DRM has made it inconvenient to upgrade or replace defective hardware when the media is licensed to an individual device.

For TV shows and music broadcasted publically, they have historically been supported via advertising revenue rather than by direct sale to the consumer. While generally accepted and tolerated, some consumers prefer to watch without the advertising. With the advent of the Personal Video Recorders (PVRs), these viewers have been able to bypass this revenue generating mechanism with greater ease.

Applying an advertising model to other aspects of the digital world, service providers such as news websites, file storage, travel maps, email and many mobile applications (‘apps’) have been able to provide their services free-of-charge to clients via an advertising model. However, the same problem of consumers bypassing advertisement created by the PVR for TV shows and music also holds true for websites with internet users installing ‘Ad Blocker’ type software which prevent advertisements from appearing on their screens.

Despite the advent of ‘Ad Blocker’ type software, many websites and electronic content providers still provide their service using an advertising model. There are many types of advertising models and methods of delivering and selling ads. One way advertising can be sold is through an auction and bidding system. For example, Google's AdWords™ is a bidding system often used for websites. More recently, some mobile apps and websites have started to use a real-time bidding (RTB) system for ad placement, where the ad network allows advertisers to bid for placement in a website or in an app or in a category of websites/apps or keywords based on many criteria including bid amounts, time of day, and popularity of the site or app. An example of an RTB advertising system is Microsoft's pubCenter™ which has real-time bidding for ad space in Apps.

While the advertising supported content distribution may work for some, there are many potential clients that wish to have advertising removed—preferring to sell or distribute content under what is often known as the ‘freemium’ model (providing both a free and premium version of the service.)

With the ‘freemium’ model for software and cloud services, the onus falls on the content developer to provide two versions of the offering, as well as to maintain the infrastructure necessary to securely process payment for users wishing to move from ‘free’ to ‘premium’ offerings. Premium product offerings would normally not be free.

It has also been shown and discussed, that ‘paid’ software with a free, unlimited and ad supported trial will not be downloaded as often as an app that is offered in two formats: free with ads; and a paid, premium version without ads. For example, the developer of Tic-Tac-Toe Toe 3D for Windows phone discuss in his blog post of Jan. 31, 2011 5:58:24 PM “Windows Phone 7: Trial (Paid) vs. Free (http://devblog.ailon.org/devblog/post/2001/01/31/Windows-Phone-7-Trial-(Paid)-vs-Free.asp, accessed on Dec. 21, 2011) that for his app, there was 40× more visits on his free app than a paid version of the app. In discussions by the inventors with other developers on the Windows Phone 7 ‘apps’ forums, similar opinions about the popularity difference between paid and free apps were raised.

### SUMMARY OF THE INVENTION

In the present invention media content is delivered to the user in an advertising model wherein users can bid against the advertisers, or advertising systems or engines to have the advertisements (ads) removed. The bid to remove advertisements can be locked to a particular device, a user account, for a time period, a number of uses or read-throughs or other criteria as applicable. For example, the time period for the media can be set by the publisher based on their terms and conditions. A book publisher may offer a single read-through for a book, where a magazine publisher may offer a month of unlimited reading for an issue.

There can be many formats or methods for the bidding process. For example, the bidding can take the form of a specific advertisement removal price offered to the user who may simply respond by accepting or rejecting the offer. The user may also be presented menu of options such as the number of devices or platforms, the time period, the number of uses or read-throughs or other criteria with the offer price to be determined by the system after the user has selected the preferred options.

The bidding can also be an auction like process where there user makes one or a number of bids against a reserve price established by the advertising system.

The offer price or the reserve price described above can be determined in real time or predetermined based on the advertiser's preference.

The advertising system of the present invention can be implemented or added to digital media content by many different parties involved. For example, the system can be implemented by the author, the publisher, the book store, the app store, other content owners, distributers, or relevant parties. The advertising system of the present invention provides the user with an opportunity to bid against any party or parties seeking to present advertisement to the user.

In the case of content supported by ads and bidding, the publisher may define a time period for the out-bidding to be in effect. In the case of Apps, it may be for as long as the app is installed, or the current version, or a time period of a year or month. In the case of recurring print media such as magazines and periodicals, the bid may cover a single issue or edition, or may be a monthly or yearly subscription.

In the present invention, media such as software, mobile apps, books and TV shows are among, but not limited to the items that are provided to the users to use, using the advertising model of the present invention.

By providing the user with the opportunity to engage with advertisement process actively, this user bidding advertising model encourages the user to change their perception of the product from product ownership to passively using the product.

With media using a bidding ad system of the present invention, publishers may also receive advertising revenue from the public library system. Using this system, the library does not have to manage the DRM process, nor payments to the publishers. At the same time, any reader/viewer can still bid the ads out of the media, or view the media free-of-charge while being presented with ads.

This ad bidding system of the present invention can greatly reduce media piracy by no longer locking the media via a DRM scheme, making distributed copies of the media free. Revenue is still generated via either displayed ads, or consumers bidding to remove the ads.

### BRIEF DESCRIPTION OF THE DRAWINGS

The system and method may be better understood with reference to the following drawings and descriptions. Non-limiting and non-exhaustive embodiments are described with reference to the following drawings. The drawings are not necessarily to scale, emphasis instead being placed upon illustrating the principle of the invention. Other aspects and embodiments of the invention are also described without drawings in the following description.

FIG. 1 depicts a flow chart illustrating one embodiment of an exemplary advertising system as applied to an eBook while being used in an online environment (i.e. with internet connectivity).

FIG. 2 depicts a flow chart illustration another embodiment of this type of Ad bidding system when applied to eBooks while in an offline environment (i.e. without internet connectivity).

FIG. 3 depicts a flow chart illustration another embodiment for a user's bidding flow which will determine whether ads will be removed or displayed.

FIG. 4 depicts a flow chart demonstrating the flow of the advertising system of the present invention within an App

FIG. 5 is a representation of a page of an eBook displayed in a typical eBook reader with a sample advertisement.

FIG. 6 is a representation of the same page of the eBook of FIG. 5 displayed in a typical eBook reader with the advertisement removed as a result of a successful bid by the user to remove advertisements.

FIG. 7 illustrates an embodiment of an advertising system embodying aspects of the invention.

FIG. 7a illustrates an embodiment of the advertisement network server, also referred to as the ad network server, of FIG. 7.

FIG. 7b illustrates an embodiment of the client of FIG. 7, and more particularly illustrates an embodiment of a digital content display device client.

FIG. 8 depicts a flow chart illustration another embodiment of a user's bidding flow which will determine whether ads will be removed or displayed.

### DETAILED DESCRIPTION

In our invention, media such as software, mobile apps, books and TV shows are among, but not limited to the items that are provided to the users, using an advertising revenue model.

Media is delivered to the user on a device with the ability to display advertising by querying a server on the internet. For an embodiment of the invention where the advertising system returns an image and a click URL, the device (or book reader, smart phone, or other device capable of displaying digital media) would need to have the capacity and/or allow fetching of images from the internet and opening a web browser to the clicked URL.

In an embodiment of the invention, the device may need to also understand that the media (book, video, etc) may not be allowed to be read if the device is offline or without being connecting to the advertising system.

The advertising space on the device or digital media can then be sold using standard practices. Examples of such practices include pre-selling advertising space to advertisers and selling advertising space in real time using active bidding processes.

In the advertising system of the present invention, the user bid against the advertisers to have the ads removed. The price of the bid necessary to have the ads removed may depend on the sale price of the advertising space to the advertiser. It can be determined based on the pre-selling price for ads pre-sold or determined real time when the advertising space is sold using a real-time bidding system.

Ads can be returned as a graphic image such as JPG, PNG, or GIF. Simple animated ads can be returned as scripted animation such as Flash or Silverlight. For either of these types of ads, a customer-bid instance (when the customer has bid for use of the content with no ads), the advertising system can simply return an empty image/script with a size of 0 height and width—the rendering software can then adjust screen layout based on the ad size. No changes would be required when the ads are bid out of the instance. In more complex instances where a specialized advertising control or implementation system is used such as AdMob™, or pubCenter™, as opposed to a simple implementation of returning a simple image, the ad control can show/hide itself depending on the bid state, and the screen can be laid out to reflow and make use of the space.

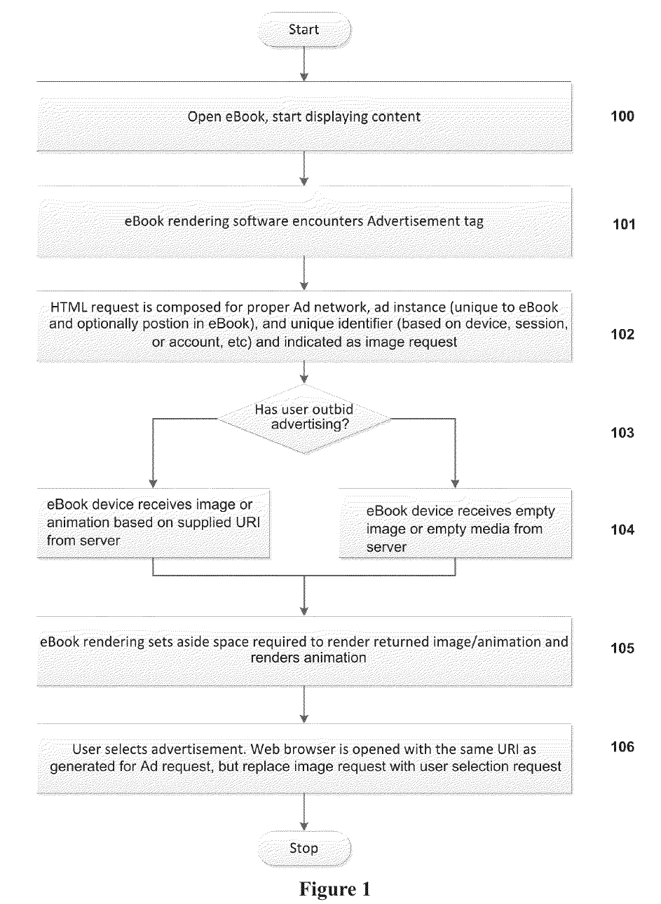

FIG. 1 depicts a flow chart illustrating one embodiment of an exemplary advertising system as applied to an eBook while being used in an online environment (i.e. with internet connectivity).

The user opens an encoded eBook on device enabled with the advertising system of the present invention 100 The user may have already been offered a chance to outbid the advertising, for example at the point of download, when first selecting the book for reading, or when visiting a website. The user may also be provided with an opportunity to outbid the advertising in a book properties screen. The user may also be provided with the opportunity to outbid the advertising when the first ‘ad’ is rendered which may be an offer to remove further ads. The user may have already outbid advertising for all devices, a number of devices, a single device, only devices linked to the user's account, a specific number of uses, or any other bid specification that may be applicable to this eBook. These prior bid information may be stored on or available to the ad network's server.

During the normal course of rendering the eBook for display the device comes across an Advertisement tag (101) and proceeds to compose a request for the desired ad media from an ad network and sends the requests to the ad network's server (102) The request would contain the unique ad identifier (unique to that book, publisher, and optionally to a position in an eBook, for example) as well as some method of identifying the current instance of reader/device and may be in the form of MAC address matching, cookie, session code, login, user account information, etc.

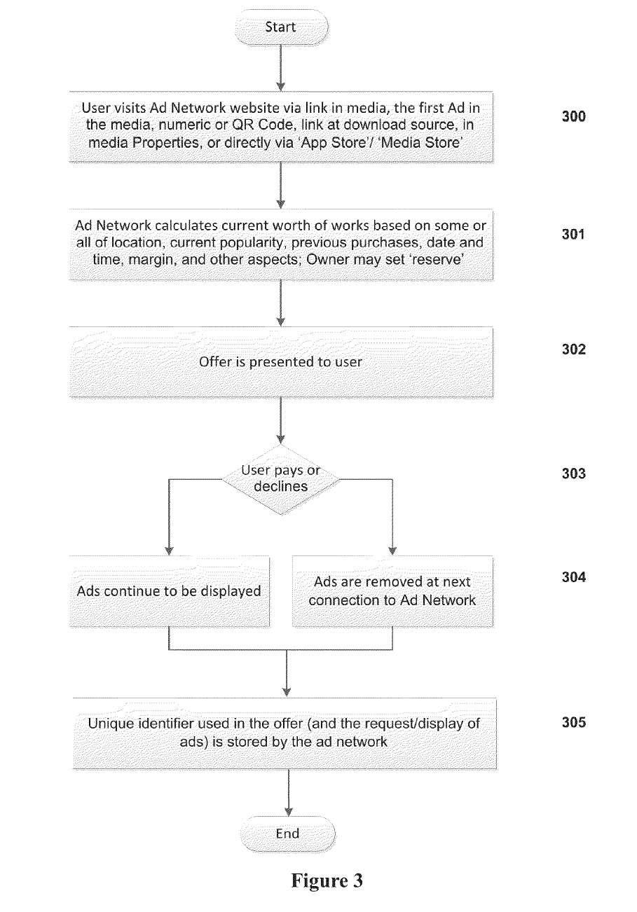

The server receives the request and determines if this instance had been outbid for ads (103), and returns (104) either ad inventory (based on ad network specific criteria of willing advertisers and their bids, categories, location, time and date, etc.) or returns empty media. 103 may be expanded along the lines of 301 to 305 as detailed in FIG. 3.

Since most eBook rendering systems will render eBooks containing embedded images, 105 the reader may simply treat this ad media as embedded images, setting aside space for the ad, reflowing the text around the image/animation, and then render the image/animation as directed. The eBook rending system would simply ignore media of null size and treat that advertisement tag as nonprintable codes. Other systems for removing advertising or advertising space may also be used, depending on the type of device being used to view the content.

If and when the user selects the advertisement for more details (106), a window/screen is displayed with extra information. One implementation for displaying this extra information would be to simply create a web Uniform Resource Identifier (URI) in the same manner the image/media request was, and display a web browser to the user where any content desired can be interactively displayed, as returned by the server. The browser could even be forwarded to the advertiser's website.

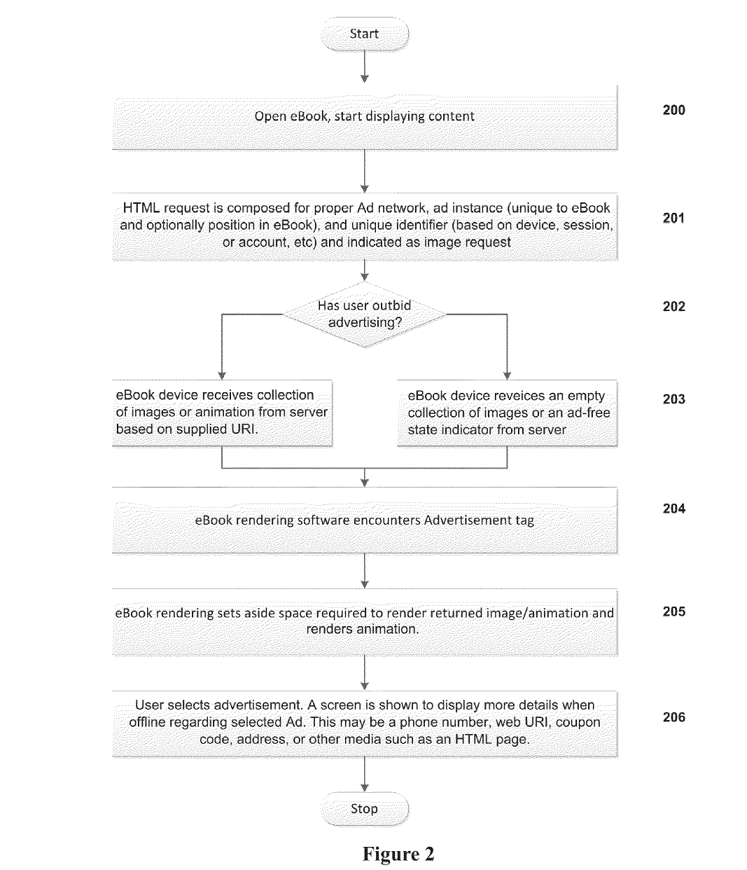

FIG. 2 depicts a flow chart illustrating another embodiment of this type of Ad bidding system as applied to eBooks being used in an offline environment (i.e. without internet connectivity).

Users may wish to use the media offline, especially in the case of some mobile apps or eBooks while roaming out of country. This may be due to the inability to gain a connection (for example, on an airplane or cruise ship) or just the expense of mobile cellular data when roaming in another country. Microsoft mentioned in its Ad network documentation for Windows Phone 7, that the developer may choose to shut down the app or remove features when the network is not available. The Windows Phone 7 documentation can be found at:
1. http://msdn.microsoft.com/en-us/library/gg132903(v=MSADS.10).aspx
2. http://msdn.microsoft.com/en-us/library/ff1973757(MSADS.10).aspx
3. http://4mkmobile.com/2010/12/adventures-in-wp7-ad-publisherspart-1/
4. http://msdn.microsoft.com/en-us/magazine/hh288088.aspx-1st paragraph in “About Advertising.

For these types of situations, the advertising system of the present invention can offer the media for purchase with a bid for ad-free use. Bidding solves the problem ad networks have when there is no internet connection to serve the ad. Since the ads are not displayed, the network connection is not required and developers will not need to program their apps or eBooks to shut down or have features removed when the ad network is not available.

The user opens encoded eBook on a device enabled with the advertising system of the present invention 200. The user must have already been offered a chance to outbid the advertising at point of download, when first selecting the book for reading, when initially acquiring the book or any other available opportunities while the user is able to connect to the advertising network. The device proceeds to request the desired ad media from the ad network 201. The request would contain the unique ad identifier (unique to that book, publisher, and possibly position) as well as some method of identifying the current instance of reader/device and may be in the form of MAC address matching, cookie, session code, login, etc. Depending on the user's choice and whether they have outbid the advertising 202, an advertising bundle is downloaded 203, or an empty bundle or some sort of outbid indicator is returned. The renderer may elect to not allow offline reading unless the advertisers have been outbid.

For offline use such as represented by the embodiment described in FIG. 2, the device would download one ad for each unique ad identifier in the media (for example one per chapter, or one per page, etc.) It would make sense for speed and reliability to combine all ads into a single file the same way a ZIP file combined several files into one. In contrast, user bidding for an online use embodiment, the ads may be downloaded in real time as the advertising tag is encounter during use of the media to take into account the possibility of use of the media over an extended period of time, such as several weeks or months. Advertising needs, prices, bid may change during this period of time, for example to accommodate special advertising during the Christmas season.

During the normal course of rendering the eBook (204) for display the device comes across an Advertisement tag and check the response cached or otherwise stored from 202.

Since most eBook rendering systems will render eBooks containing embedded images, 205 the reader may simply treat this ad media as an embedded image, setting aside space for the ad, reflowing the text around the image/animation, and then render the image/animation as directed. The reader would simply ignore media of null size as treat that advertisement tag as nonprintable codes.

If and when the user selects the advertisement for more details (206), a window/screen is displayed with the extra information cached bundled with the ad media. The window would display information such as coupon code, website, phone number, or other static information—possibly even a simple webpage.

FIG. 3 depicts a flow chart illustrating the user's bidding flow which will determine whether ads will be removed or displayed. The user is directed (300) to the bidding location, it may be part of the distribution platform (App Store, Media Store), within in the rendering device/software, or on a website.

The Ad network calculates an offer to remove ads 301. An example for calculating an offer to remove ads from an eBook is as follows:
The offer to remove ads=greater of the sum of current earnings from single impression of each ad in a book plus a premium, the premium can be set by the publisher, the advertiser, the advertising system and/or other entities involved in the advertising process

Earnings per impression would be calculated as per that of the ad network-based on current media, date/time, location, user, popularity of media, or any other criteria that the ad network wish to use. This can even fluctuate in real-time, but bidding offers would be calculated at a current ‘snapshot’.

Another example for the price to remove ads from an eBook is a reserve price set by the publisher.

The offer 302 is presented to the user and the user either accepts and pays (via online payment, credits, tokens, points, or whatever ‘currency’ is accepted) for removing the ads, or declines and ads continue to be served 303. The device will then either continue to display the ads or remove the ads at the next connection to the Ad network 304. The ads can be removed by any method suitable to the device. If the page/screen is rendered with an Ad already, the screen may not update as soon as a bid was accepted, but may need to be refreshed.

The ads can be removed by any method suitable to the particular device where the ads have been outbid. A device may need to be configured to interact with the ad server, understands properly the commands to display or remove ads from the ad server and have the capacity to process the commands into instructions to remove the ads from the device's display. For example, an eBook reader may simply ignore media of null size as treat that advertisement tag as nonprintable codes.

The unique identifier used in both the offer, and request/display of ads is then stored by the ad network to ensure outbid ads are then removed, if chosen 305.

In another embodiment, the user may also choose to ignore the offer, for example, when the offer is presented as the first advertisement in the media. In that case the ad server can record the offer as declined or ignored, depending on how the content owner or advertiser wishes to generate another offer at a later time directly or wait for the user to request or make another offer at a later time.

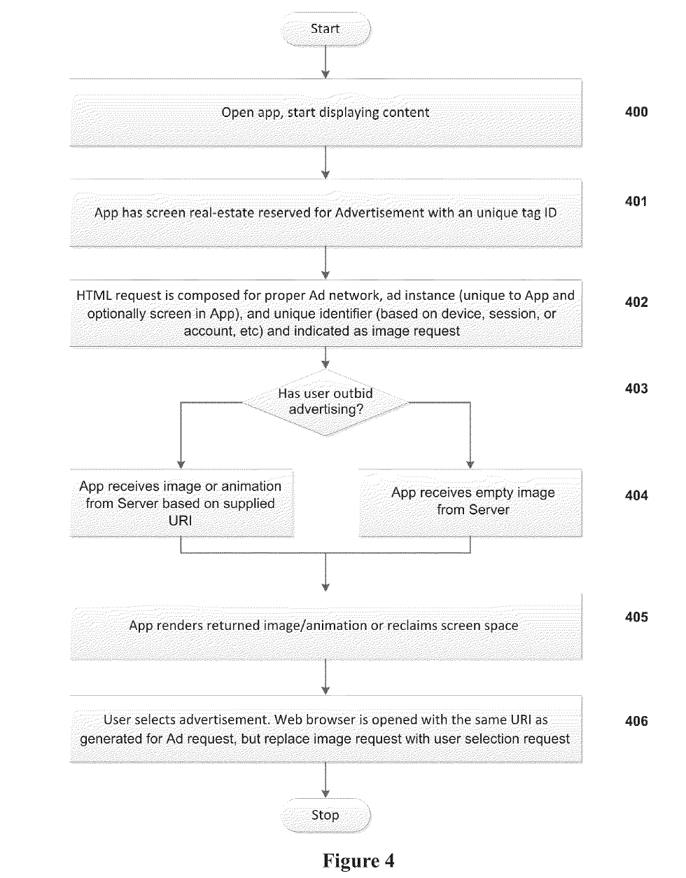

FIG. 4 depicts a flow chart illustrating the flow of the advertising system of the present invention within an App, starting with opening the app 400. The screen is laid out (401) such that space is reserved for display of ads and but also in a manner such that space reserved for ads may be reclaimed if ads are bid out of the app—each ad location is tagged with an ID unique to either that app, or that screen.

A request (402) is made to the ad network for an image/animation to display in the space reserved for ads. The instance of this app/user is uniquely identified (by MAC address, device ID, or some other means) and is sent with the request.

If (403) the server determines the user has outbid the ads, and it still within the timeframe of the offer (App publishers may opt to offer ad-free for the life-time of the app, of the device, or a specific time—such as a month or year then the server returns a signal (404) to remove the ads and reclaim the screen space for the apps own uses. Otherwise, the server returns an image or animation to be displayed in the screen space set aside (405).

If and when the user selects the advertisement for more details (406), a window/screen is displayed with the extra information. One implementation would be to simply create a web URI in the same manner the image/media request was, and display a web browser to the user where any content desired can be interactively displayed, as returned by the server. The browser could even be forwarded to the advertiser's website.

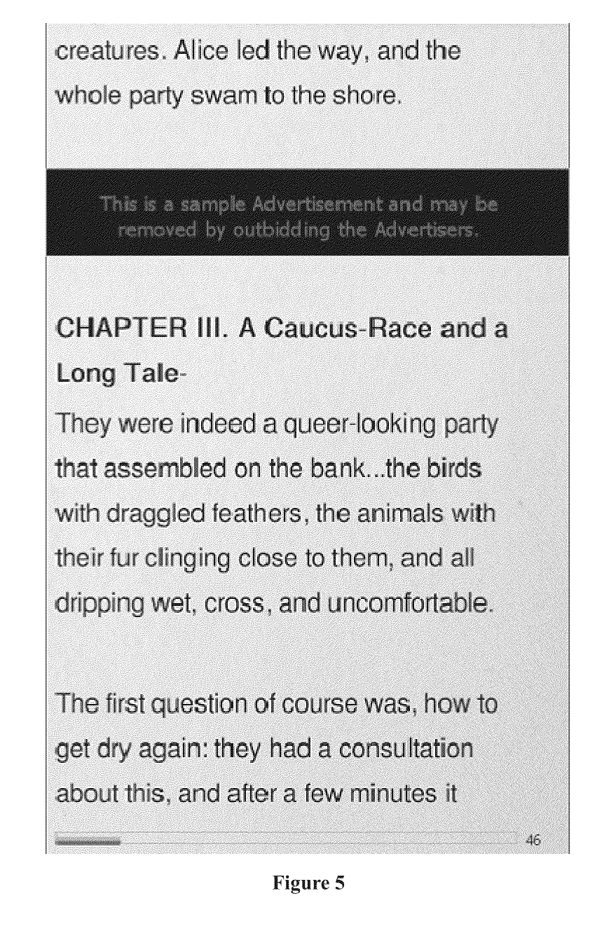

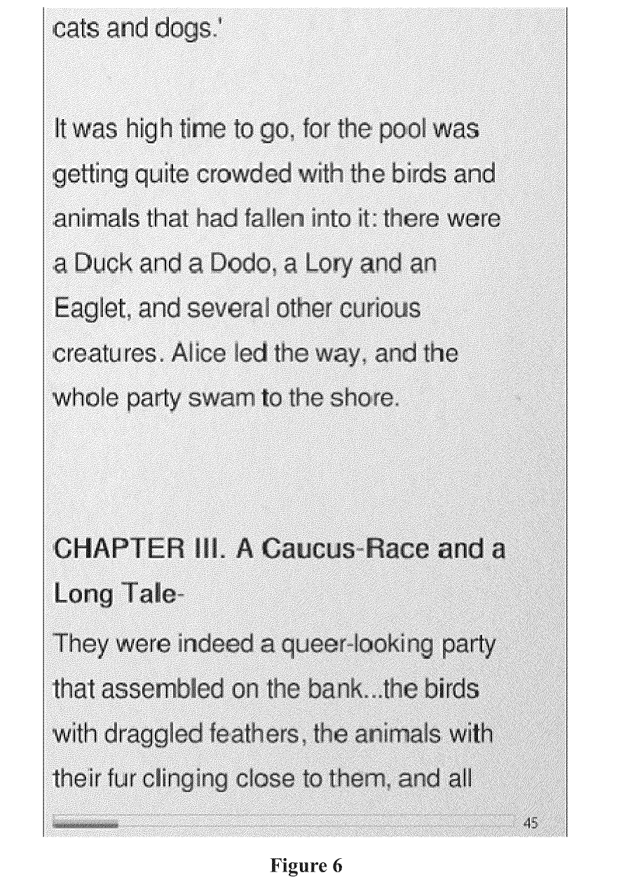

FIGS. 5 and 6 represents a typical eBook reader with the Ad bid network enabled. They both show the same eBook, and roughly at the same location in the eBook. In FIG. 5, the advertisement is displayed. In FIG. 6, the user has successfully bid to have the advertisement removed. When the ads are enabled in every page, the page count changes due to the extra space taken up by the ads. With ads bid out, the book reflows to reclaim the space taken up by the ads, and provides an ad-free experience.

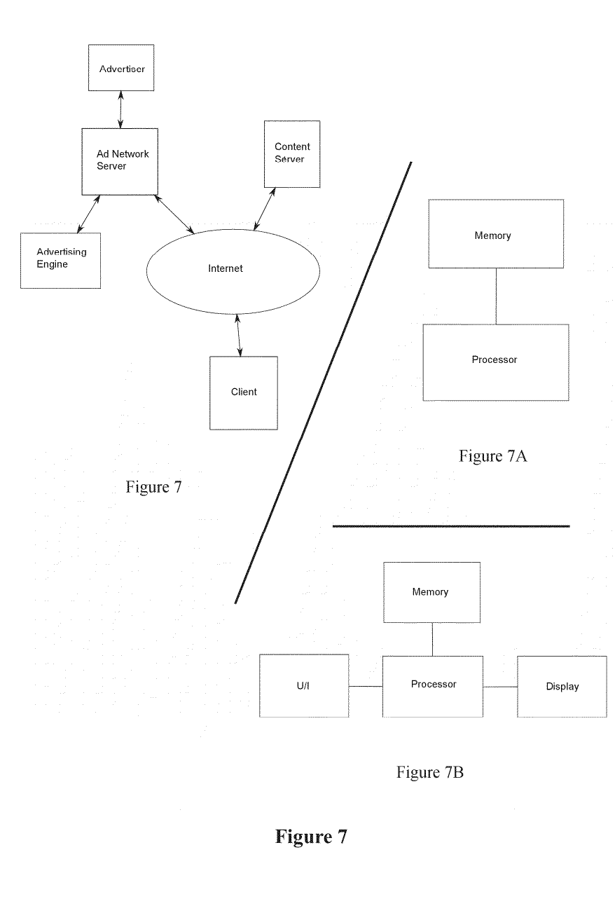

FIG. 7 illustrates an embodiment of an advertising system. In this embodiment, a client, i.e. user device, is communicatively linked to the internet. A content server is also communicatively linked to the internet allowing the client to access digital content supported by advertising. One or more ad network servers are communicatively linked to an advertiser via one or more advertiser servers, who may bid directly for advertising on the client and to an advertising engine (for example AdMob™ or pubCenter™) who would process bids from advertisers via advertiser servers and then forward those bids to an ad network server. When the client encounters an advertisement instance, it may communicate with the ad network server via the internet for the purpose of requesting an advertising bid, sending the response to the bid to the ad network server, receiving the advertisement contents or ad removing signal, and receiving and sending other communications that may be required.

FIG. 7a illustrates an embodiment of a server and more particularly an embodiment of a server described as part of the present invention wherein the invention is embodied as an ad network server. The server comprises a memory and a processor. Similarly a content server would also comprise a memory and a processor.

FIG. 7b illustrates an embodiment of a client digital content display device and, more particularly, illustrates an embodiment representative of an eBook in FIG. 7b. The device comprises a memory, a processor, a user interface, and a display.

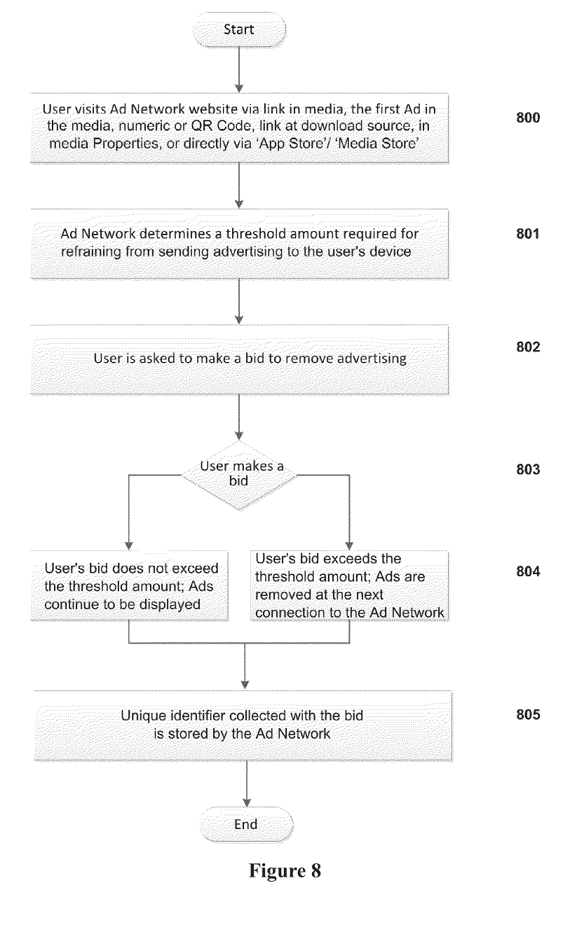

FIG. 8 depicts a flow chart illustration another embodiment of a user's bidding flow which will determine whether ads will be removed or displayed. The user is directed (800) to the bidding location, it may be part of the distribution platform (App Store, Media Store), within in the rendering device/software, or on a website.

The Ad network determine a threshold amount required for refraining from sending the advertising to any single user device 801. For example, it the threshold amount may be a sum of the advertising cost amount attributable to a single user device plus a premium

The ad network then instructs the device to ask the user for a bid to remove the advertising 802.

The server receives a request from the given user device to refrain from sending the advertising along with a bid amount 803.

Where the bid amount exceeds the threshold amount 804 the ad network will then refraining from sending the advertising to the given user device. It may also continue sending the content to the given user device if the advertising tag has interrupted the transmission of the content.

Where the bid amount does not exceed the threshold amount 804, the ad network will send the content to the given user device with the advertising to the given user device, the advertising system.

In another embodiment, the default behaviour of the user's device may be to display advertisements without requesting a user bid. In order to bid to remove ads, the user may have to access the bidding process through a separate process, such as accessing it through the book properties screens on an eBook reader or through their user accounts setting linked to their device.

The user bidding advertising-based model of the present invention encourages the user to change their perception of the product from product ownership to passively using the product by directly engaging the user in the advertising process. The media producer still owns all the product content, while the user can freely use the product in whatever device they choose. For example, a book can move freely between an e-reader device, a PC, and a smart phone. Or between an old and new smart phone without the problem of licensing or DRM, since the media is ad supported and rights do not need to be managed. The only cross-device considerations are when the user has bid to have the ads removed. In this case, the bid may have been for a single device, or might be based on an account. If all devices use the same account, the ad service should automatically handle this case, and remove ads in all devices, or maximum simultaneous devices per account.

A real-time bidding ad network can also take location into account for delivering ads, or accepting bids from customers. Using the internet IP address, the ad network knows at least which country the request is coming from, if not the general state/province or city. This allows marketing ads of a localized nature or even targeting to grow awareness of the product in a certain geographic area by reducing or eliminating ads for those locations.

Copying and sharing can be encouraged using the advertising revenue model of the present invention. As the media reaches a wider audience and gains popularity, so does the ad revenue. Without DRM, media can be placed on any servers, including file-sharing and social media. This may reduce the bandwidth and infrastructure required to distribute the media as content owners no longer needs to have content stored in a protected or encrypted manner, for example on their specialized server. The media, apps, eBooks and other content can be copied and shared with ads is already in place. Content supported using this advertising revenue model can be distributed more freely thereby reducing the burden on content owners.

For media publishers for media such as TV shows and books, the advertising system of the present invention can provide information related to the customer's usage of the media that may not have been readily available to publishers before. For example, the ad server in the advertising system can provide information such as the number of clients starting reading or viewing the media vs. the number of clients who completed based on a how many customers reach the first advertisement and how many customers reach the last advertisement. In the area of books, the advertising system of the present invention can provide the publisher with information and metrics for published works beyond raw sales figures. Other examples of customer information that can be provided to book publisher by the system of the present invention include average read time (depending on unique identification) and reading rate (time between two ads in an item.)

Software app publishers have had this type of information in ad supported apps by placing different ad ids on different screens of the app. However, this information is lost when a user upgrades to an ad-free version. In the case of the advertising system of the present invention, the ad server is still queried and thereby providing the publisher information regarding the customer experience.

Media publishers have often found it difficult to quickly change the price of items as popularity grows and wanes. Especially with media sensations where popularity may grow quickly due to some unforeseen social reason, and then quickly decline. The advertising system of the present invention includes a real-time ad bidding service allowing the advertisers to adjust the perceived worth of an item as popularity and trends change, and yet, a customer can still bid and pay the going rate in order to enjoy the item ad-free. For example, the ad bidding system can allow publishers to adjust the price of advertisements based on user's bidding behaviour. In the simple case of a downloaded TV show, if there are 5 ad segments and the bid is $1000 eCPM (cost per 1000 impressions) then the show is currently worth $5. In order words, if there are 5 ad segments in a show, then this comprises 5 impressions and is valued at $5 in this example. Accordingly, a user can pay $5 to watch the show ad-free. If later, the eCPM drops to $500, the user could opt to pay $2.50 to watch the show without the advertising. Optionally, the publisher may be able ‘bid’ for their own ad space to promote products, updates, or fill when there are no or extremely low bids.

An advantage of the advertising system of the present invention is that revenue made through advertising within mobile apps is treated differently than revenue generated through sales of the app. Several mobile ‘App Stores’, such as Apple's App Store have a policy where items cannot compete with their store offering. If a media publisher wishes to sell media directly to the customers on the Apple platform, for example on the iPhone, iPad, or other apple devices and platforms, they must do so through Apple's iTunes where Apple retains a portion of the proceeds. This holds true for Music, Video and Books. Free or ad supported content is allowed. The bidding ad system would allow publishers or book sellers (such as Amazon, and Kobo) to provide the material to the customer free of charge in a single format which incorporates in principle both the ad-supported and premium version and allow the end user to bid for the media without advertisements outside of an App Store. This can be extended into App sales allowing for apps to be in the ‘free’ section of the App Marketplace or App Store (and not flagged as a trial app) and still allow the app to run ad-free when bid for. Furthermore Apple allows developers and publishers to choose their own ad system they wish and revenue is wholly directed to the advertiser and/or the ad system without Apple or another app store taking a cut. This holds true as long as you are only removing the ads, and not adding functionality.

All documents cited herein are, in relevant part, incorporated by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this disclosure shall govern.

Various embodiments of this invention have been described. However, this disclosure should not be deemed to be a limitation on the scope of the invention. Accordingly, various modifications, adaptations, and alternatives may occur to one skilled in the art without departing from the spirit and scope of the claimed invention.

What is claimed is:

1. A server system for providing advertising to a user device, comprising:
a memory;
a processor operable to:
receive messages from advertisers comprising advertising content for displaying on said device;
send an advertising content removal offer to said device;
determine an advertisement removal bid from said device;
send advertising content to said device where said determine said advertisement removal bid determines a failing bid to remove said advertising content;
store said advertisement removal bid from said device;
wherein said failing bid is determined upon any one of (i) receiving a response declining to remove said advertising content, (ii) receiving a bid below a threshold amount, and (iii) failing to receive a response to the advertisement removal offer.

2. The system of claim 1 wherein said processor is further operable to:
refrain from sending said advertising content to said device on receiving a successful bid to remove said advertisement;
wherein said successful bid to remove said advertisement is one of a bid meeting said threshold amount and a determination that a previous successful bid associated with said device has been made.

3. The system of claim 1 wherein said messages from advertisers comprises cost information and wherein said processor determines said threshold amount based at least in part on said cost information.

4. The system of claim 3 wherein said advertising content removal offer relates said threshold amount.

5. The system of claim 3 wherein said advertising content removal offer relates an amount higher than said threshold amount, said threshold amount being a reserve amount.

6. The system of claim 3 wherein said refrain from sending said advertisements to said device comprises sending advertisement removal instructions to said device.

7. The system of claim 1 wherein said threshold amount is calculated based on situational information comprising one or more of date, time, type of device, the device's platform, geographic location, information about media being displayed on said user device, user's information including web history, preferences, past purchases; and wherein said server is operable to access said situational information.

8. The system of claim 2 wherein said advertisement removal instructions comprising, if applicable, sending a command to remove display space allotted for advertising from said user device's display.

9. The system of claim 2 wherein said
a processor is further operable to:
monitor for said advertisement removal bid from said device;
send said advertising content to said device upon failing to receive a successful bid to remove said advertisements within a time period.

10. The system of claim 2 wherein said determination that a previous successful bid associated with said device has been made comprises checking for a stored previous successful bid associated with said device.

11. A computer implemented method of handling advertising, comprising:
receiving messages from advertisers comprising advertising content for displaying on said device;
sending an advertising content removal offer to said device;
determining an advertisement removal bid from said device;
sending advertising content to said device where said determine said advertisement removal bid determines a failing bid to remove said advertising content;
storing said advertisement removal bid from said device;
wherein said failing bid is determined upon any one of (i) receiving a response declining to remove said advertising content, (ii) receiving a bid below a threshold amount, and (iii) failing to receive a response to the advertisement removal offer.

12. The method of claim 11 further comprising:
refraining from sending said advertising content to said device on receiving a successful bid to remove said advertisement;
wherein said successful bid to remove said advertisement is one of a bid meeting said threshold amount and a determination that a previous successful bid associated with said device has been made.

13. The method of claim 11 wherein said messages from advertisers comprises cost information and wherein said processor determines said threshold amount based at least in part on said cost information.

14. The method of claim 13 wherein said advertising content removal offer relates said threshold amount.

15. The method of claim 13 wherein said advertising content removal offer relates an amount higher than said threshold amount, said threshold amount being a reserve amount.

16. The method of claim 13 wherein said refraining from sending said advertisements to said device comprises sending advertisement removal instructions to said device.

17. The method of claim 11 wherein said threshold amount is calculated based on situational information comprising one or more of date, time, type of device, the device's platform, geographic location, information about media being displayed on said user device, user's information including web history, preferences, past purchases; and wherein said server is operable to access said situational information.

18. The method of claim 12 wherein said advertisement removal instructions comprising, if applicable, sending a command to remove display space allotted for advertising from said user device's display.

19. The method of claim 12 further comprising:
monitoring for said advertisement removal bid from said device;
sending said advertising content to said device upon failing to receive a successful bid to remove said advertisements within a time period.

20. The method of claim 12 wherein said determination that a previous successful bid associated with said device has been made comprises checking for a stored previous successful bid associated with said device.

21. A computer readable media containing computer executable instructions, which, when executed by a processor of a server system, cause said server system to:
receive messages from advertisers comprising advertising content for displaying on said device;
send an advertising content removal offer to said device;
determine an advertisement removal bid from said device;
send advertising content to said device where said determine said advertisement removal bid determines a failing bid to remove said advertising content;
store said advertisement removal bid from said device;
wherein said failing bid is determined upon any one of (i) receiving a response declining to remove said advertising content, (ii) receiving a bid below a threshold amount, and (iii) failing to receive a response to the advertisement removal offer.
